(19) United States
(12) Patent Application Publication
(10) Pub. No.: US 2012/0186150 A1
(43) Pub. Date: Jul. 26, 2012

(54) SYSTEMS AND METHODS FOR ENHANCING PLANT GROWTH

(75) Inventor: Santosh Yadav, Mt. Pleasant, IA (US)

(73) Assignee: Cellulose Tek, LLC, Mt. Pleasant, IA (US)

(21) Appl. No.: 13/010,562

(22) Filed: Jan. 20, 2011

(51) Int. Cl. A01G 29/00; B05D 1/36

(52) U.S. Cl. 47/48.5; 427/265

(57) ABSTRACT

A growth-enhancing element for enhancing plant growth includes a substrate and a plurality of discrete portions of fertilizer. The substrate includes at least one first layer of polymer and at least one second layer of polymer disposed over the at least one first layer of polymer. The discrete portions of fertilizer are encapsulated in the substrate such that the plurality of discrete portions of fertilizer are disposed between the at least one first layer of polymer and the at least one second layer of polymer. The discrete portions of fertilizer each have a flat side that abuts the at least one first layer of polymer and a rounded side that abuts the at least one second layer of polymer. The substrate is configured and arranged to controllably release the fertilizer from the substrate over a period of time.

### FIELD

The present invention is directed to the area of plant-related products. The present invention is also directed to systems and methods of enhancing plant growth through the use of controlled-release fertilizer and mulch, as well as systems and methods for making and using the controlled-release fertilizer and mulch.

### BACKGROUND

Fertilizers and mulches are commonly used to promote growth and health of plants. Fertilizers typically include one or more primary nutrients (e.g., nitrogen, phosphorus, potassium, and the like) in varying amounts. Fertilizers may also include one or more secondary nutrients (e.g., calcium, sulfur, magnesium, copper, selenium, iron, zinc, boron, manganese, molybdenum, chlorine, and the like). Fertilizers can be applied to plants in many different ways, including applying the fertilizer directly to soil, spraying the fertilizer on the plant itself, and the like.

Mulches are protective covers that are typically disposed over soil surrounding a plant in such a way as to retain moisture and suppress weed growth. Additionally, mulches may be used to provide nutrients to plants, promote seed germination, maintain soil temperatures, and reduce erosion. Many different materials may be used to form mulches including, for example, rubber, plastic, gravel, compost, wood chips, grass clippings, leaves, shells, paper, bark, and the like.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic top view of one embodiment of a growth-enhancing element that includes fertilizer portions disposed between layers of a polymer substrate, according to the invention;

FIG. 1B is a schematic side view of one embodiment of the growth-enhancing element of FIG. 1A, according to the invention;

FIG. 2A is a schematic top view of another embodiment of the growth-enhancing element of FIG. 1A, according to the invention;

FIG. 2B is a schematic top view of yet another embodiment of the growth-enhancing element of FIG. 1A, according to the invention;

FIG. 3A is a schematic side cross-sectional view of one embodiment of a plant disposed in a soil-filled pot, with the growth-enhancing element of FIG. 1A disposed over the soil, according to the invention;

FIG. 3B is a schematic top view of one embodiment of a plant disposed in a soil-filled pot, with the growth-enhancing element of FIG. 1A disposed over the soil, according to the invention;

FIG. 3C is a schematic side view of one embodiment of a plurality of plants disposed in soil with the growth-enhancing element of FIG. 1A disposed over the soil, according to the invention;

FIG. 3D is a schematic side cross-sectional view of one embodiment of a plant disposed in a soil-filled berm with the growth-enhancing element of FIG. 1A disposed around exposed portions of the berm, according to the invention;

FIG. 4A is a schematic side cross-sectional view of one embodiment of fertilizer portions disposed on one or more first layers of polymer, according to the invention;

FIG. 4B is a schematic side view of one embodiment of one or more second layers of polymer disposed over the fertilizer portions of FIG. 4A and the one or more first layers of polymer of FIG. 4A to form the growth-enhancing element of FIG. 1A, according to the invention;

FIG. 5A is a schematic top view of one embodiment of a portion of a pre-cut growth-enhancing element partially disposed into a roll, according to the invention;

FIG. 5B is a schematic top view of one embodiment of a portion removed from a distal end of the roll of FIG. 5A, according to the invention;

FIG. 6A is a schematic top view of another embodiment of a portion of a pre-cut growth-enhancing element that includes fertilizer portions formed into distinct groupings, according to the invention;

FIG. 6B is a schematic top view of one embodiment of a distinct grouping of fertilizer portions cut from the pre-cut growth-enhancing element of FIG. 6A, according to the invention; and

FIG. 7 is a schematic side view of one embodiment a portion of the growth-enhancing element of FIG. 1A undergoing processing to remove portions of polymer, according to the invention.

### DETAILED DESCRIPTION

The present invention is directed to the area of plant-related products. The present invention is also directed to systems and methods of enhancing plant growth through the use of controlled-release fertilizer and mulch, as well as systems and methods for making and using the controlled-release fertilizer and mulch.

Plants (e.g., trees, bushes, grasses, vines, mosses, flowers, algae, seed plants, and the like) often benefit from the use of fertilizers of mulch, or both. Use of fertilizers and mulch may each individually enhance plant growth (e.g., health, development, vitality, size, yield, and the like). Consequently, fertilizers and mulch are commonly used by people around the world.

At least some commonly-used commercial fertilizers, such as urea, dissolve quickly in water. When applied to lawns or agricultural crops, most of the fertilizer dissolves rapidly in the moisture in the soil. Often, such fertilizers dissolve at a rate that exceeds a rate at which it can be used by plants. This can cause a number of significant problems. First, the excess fertilizer can leach into the groundwater, where it can cause potentially serious environmental damage. In addition, excessive concentrations of fertilizer in the vicinity of a plant may result in a “burning” of the plant roots.

Because of these problems, it is often necessary to apply these fertilizers in several light doses throughout the growing season, rather than in a single heavy application. However, the need for repeat applications increases labor costs and increases a risk of over- or under-fertilization of plants. Moreover, repeat applications may cause physical damage to the growing plants due to fertilizer-spreading equipment repeatedly passing over the plants.

In order to avoid repeat applications, and also to reduce the risk of over- or under-fertilizing plants, various slow or controlled-release fertilizers have been developed. These fertilizers can be applied at the beginning of the growing season to provide an initial high release of fertilizer followed by a slower, gradual release throughout the growing season. Slow or controlled-release fertilizers are widely used on home lawns, public lawns, golf courses, home gardens, plant nurseries, horticultural crops, and the like.

Polymer-coated fertilizers are one type of controlled-release fertilizer. Polymer-coated, controlled-release fertilizers are typically produced by applying a water-insoluble, semi-permeable polymer layer onto the fertilizer granules. Over time, the fertilizer is released into the soil through diffusion from this semi-permeable coating.

It may be an advantage to provide a product that combines the functionality of controlled-release fertilizers with the functionality of mulch (e.g., providing nutrients to plants, promoting seed germination, maintaining soil temperatures, reducing erosion, or the like). Such a combination may reduce labor costs associated with separately applying both fertilizer and mulch. Additionally, such a combination may reduce waste associated with hastily applying either fertilizer or mulch independently when attempting to reduce labor costs. For example, hastily applying mulch or fertilizer may result in using excessive (or insufficient) product.

It may further be an advantage to provide a product that combines the functionality of polymer-coated controlled-release fertilizers with the functionality of mulch. As described herein, growth-enhancing elements can be used to enhance plant growth. Growth-enhancing elements include fertilizer disposed on a substrate formed from polymer layers (e.g., films, or the like) that function as mulch. In at least some embodiments, growth-enhancing elements include substrates formed to a desired shape or size. In at least some embodiments, the polymer layers facilitate controlled release of the fertilizer into soil surrounding one or more plants. In at least some embodiments, the polymer layers facilitate moisture retention in soil surrounding one or more plants. In at least some embodiments, the polymer layers suppress weed growth. In at least some embodiments, the fertilizer provides nutrients to plants. In at least some embodiments, the polymer layers promote seed germination. In at least some embodiments, the polymer layers prevent soil temperatures in proximity of a plant from dropping to a harmful level. In at least some embodiments, the polymer layers reduce soil erosion.

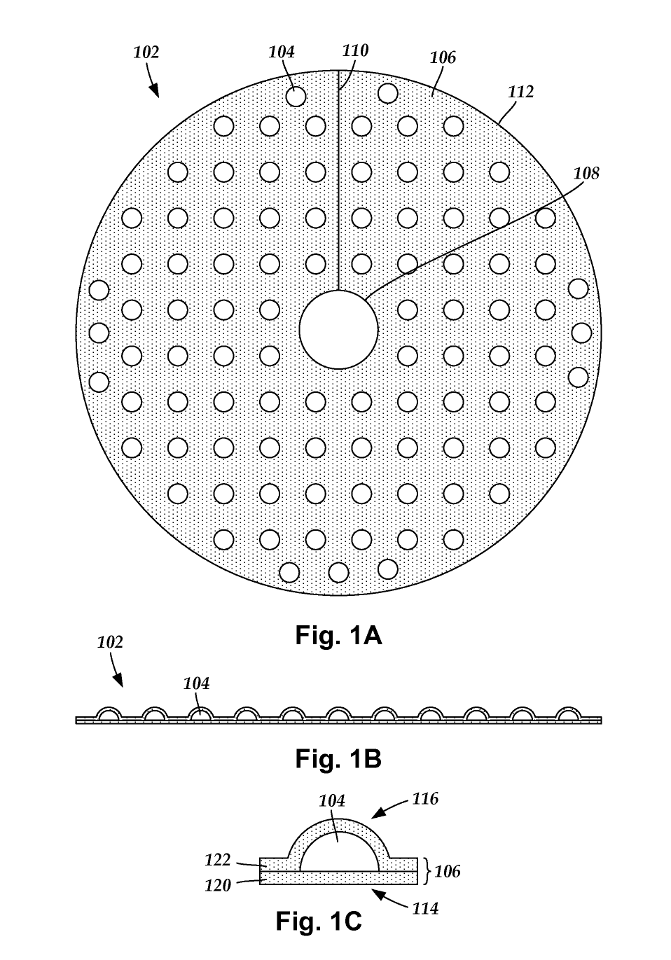

FIG. 1A is a schematic top view of one embodiment of a growth-enhancing element 102. FIG. 1B is a schematic side view of one embodiment of the growth-enhancing element 102. FIG. 1C is a schematic close-up side view of a portion of the growth-enhancing element 102. The growth-enhancing element 102 includes discrete portions of fertilizer, such as fertilizer portion 104, disposed on a substantially-flat substrate 106 having major opposing surfaces. The substrate 106 is formed from layers of one or more polymers. In at least some embodiments, the growth-enhancing element 102 defines a cut-out 108 in the polymer substrate 106 and a cut 110 in the polymer substrate 106 connecting the cut-out 108 to an edge 112 of the polymer substrate 106. In at least some embodiments, the cut-out 108 is configured and arranged to receive a stem, stalk, or trunk of a plant when the growth-enhancing element 102 is disposed over soil around a plant.

The fertilizer 104 may be any suitable fertilizer, such as urea. In at least some embodiments, the fertilizer portions 104 each include a flat side 114 and an opposing rounded side 116. The fertilizer 104 may be disposed in the substrate 106 in any formation, orientation, or distribution, including either regular or irregular formations or distributions. Each individual fertilizer portion 104 may have any suitable spacing between adjacent fertilizer portions 104. In at least some embodiments, the fertilizer portions 104 are of similar sizes. In at least some alternate embodiments, at least one of the fertilizer portions 104 is of a size that is different from at least one other fertilizer portion 104. In FIG. 1A, the fertilizer 104 portions are shown as similarly-sized portions evenly distributed along the substrate 106 in a regular pattern.

In at least some embodiments, the fertilizer 104 is distributed along the substrate 106 such that the fertilizer is released from the substrate 106 over time in a controlled manner. In at least some embodiments, the fertilizer 104 is disposed in the substrate 106 such that fertilizer 104 is released from the substrate 106 over a period of time that is at least one month, two months, three months, four months, five months, six months, seven months, eight months, nine months, ten months, eleven months, one year, fourteen months, sixteen months, eighteen months, twenty months, twenty-two months, two years, or more. It will be understood that the fertilizer 104 can be disposed in the substrate 106 such that fertilizer 104 is released from the substrate 106 over other periods of time, instead.

The release rate for the fertilizer 104 may be affected by many different factors including, for example, temperature, humidity, precipitation, and the like. In at least some embodiments, the release rate for the fertilizer 104 is controlled, at least in part, by at least one of the composition, application method, or the thickness of the substrate 106. In at least some embodiments, the substrate 106 includes one or more first layers 120 and one or more second layers 122. In at least some embodiments, the fertilizer 104 is disposed between the one or more first layers 120 and the one or more second layers 122. In at least some embodiments, the fertilizer 104 is disposed between the one or more first layers 120 and the one or more second layers 122 such that the flat side 114 of the fertilizer portion 104 abuts the one or more first layers 120 and the rounded side 116 of the fertilizer portion 104 abuts the one or more second layers 122. In at least some embodiments, the one or more second layers 122 are transparent so that the fertilizer portions 104 are visible through the one or more second layers 122.

Any suitable polymer substrates (e.g., films) may all be used to form the substrate 106 including, for example, virgin/recycled polyethylene, biopolymers, polypropylene, polystyrene, high impact polystyrene, acrylonitrile butadiene styrene, polyethylene terephthalate, polyester, polyamides, polyvinyl chloride, polyurethanes, polycarbonate, polyvinylidene chloride, polylactic acid, starch based polymers, aminoplastic resin, and the like. In at least some embodiments, the one or more first layers 120 and the one or more second layers 122 are formed from the same polymer. In at least some alternative embodiments, the one or more first layers 120 and the one or more second layers 122 are formed from different polymers. In at least some embodiments, the one or more first layers 120 are formed from multiple layers of the same polymer. In at least some embodiments, the one or more first layers 120 are formed from a plurality of different polymers. In at least some embodiments, the one or more second layers 122 are formed from multiple layers of the same polymer. In at least some embodiments, the one or more second layers 122 are formed from a plurality of different polymers.

In at least some embodiments, the substrate 106 defines one or more perforations to improve air flow across the substrate 106. In at least some embodiments, the substrate 106 can be impregnated with one or more insecticides. In at least some embodiments, the substrate 106 can be impregnated with one or more herbicides. In at least some embodiments, the substrate 106 can be impregnated with one or more fragrances (e.g., one or more floral scents, such as a rose, one or more fruit scents, such as a tomato, or the like). In at least some embodiments, printed materials (e.g., names, instructions, advertising, manufacturing information, contact information, or the like) can be disposed along at least one side of the substrate 106. The substrate 106 can be formed in any suitable color.

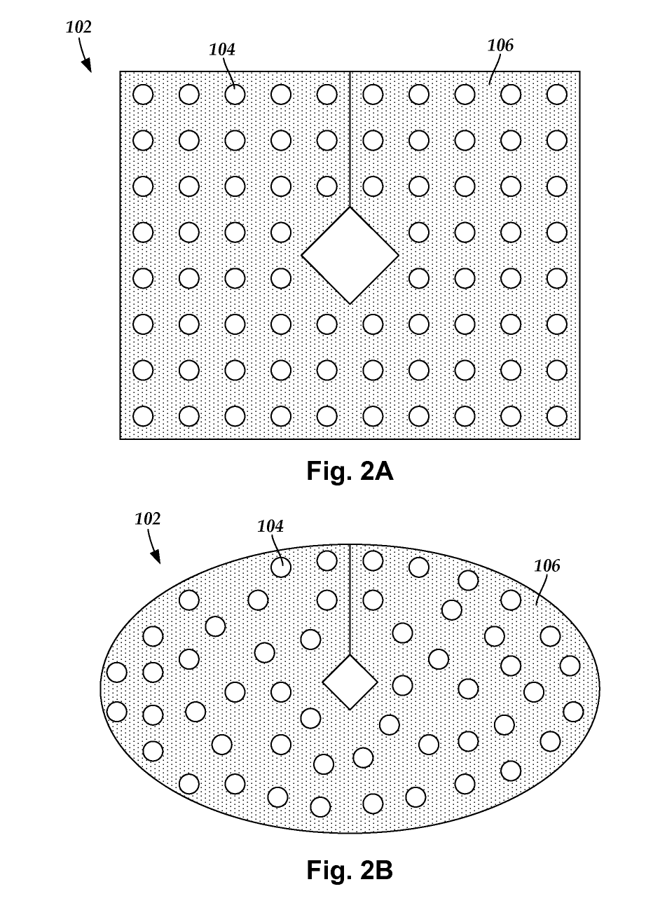

The growth-enhancing element 102 can be formed in any suitable shape and size including, for example, round, oval, rectangular, pentagonal, hexagonal, heptagonal, octagonal, nonagonal, decagonal, or the like. In at least some embodiments, the growth-enhancing element 102 is an irregular shape. In FIG. 1A the growth-enhancing element 102 is shown as being round. FIG. 2A is a schematic top view of another embodiment of the growth-enhancing element 102. In FIG. 2A the growth-enhancing element 102 is shown as being rectangular. FIG. 2B is a schematic top view of yet another embodiment of the growth-enhancing element 102. In FIG. 2A the growth-enhancing element 102 is shown as being oval-shaped. In FIGS. 1A-2A, the fertilizer portions 104 are shown distributed in evenly-spaced rows and columns. In FIG. 2B, the fertilizer portions 104 are shown having an irregular distribution. It will be understood that the fertilizer portions 104 can be distributed on the substrate 106 in any suitable configuration.

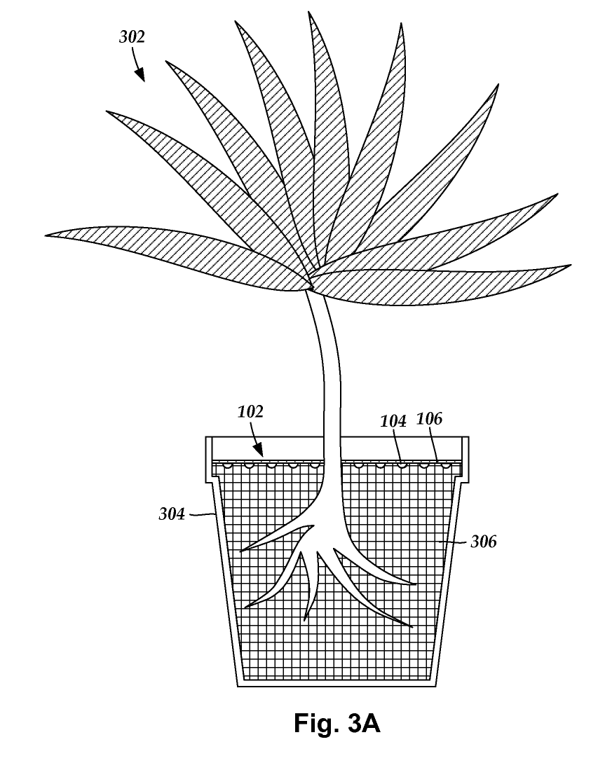

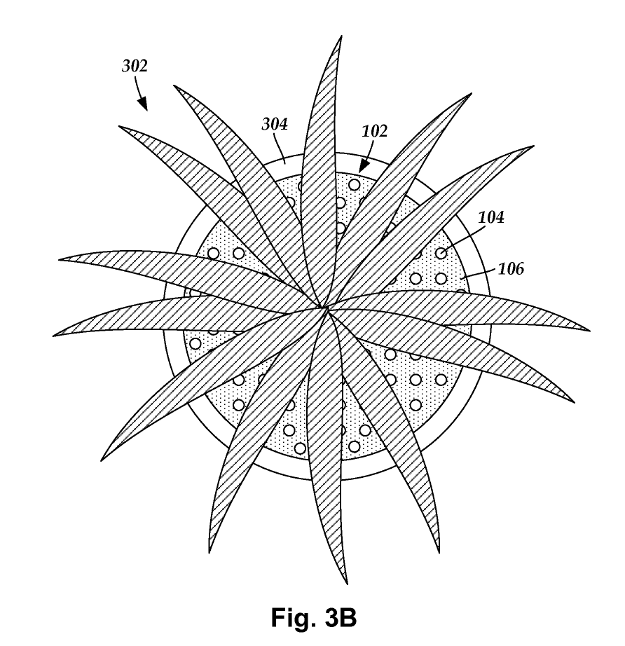

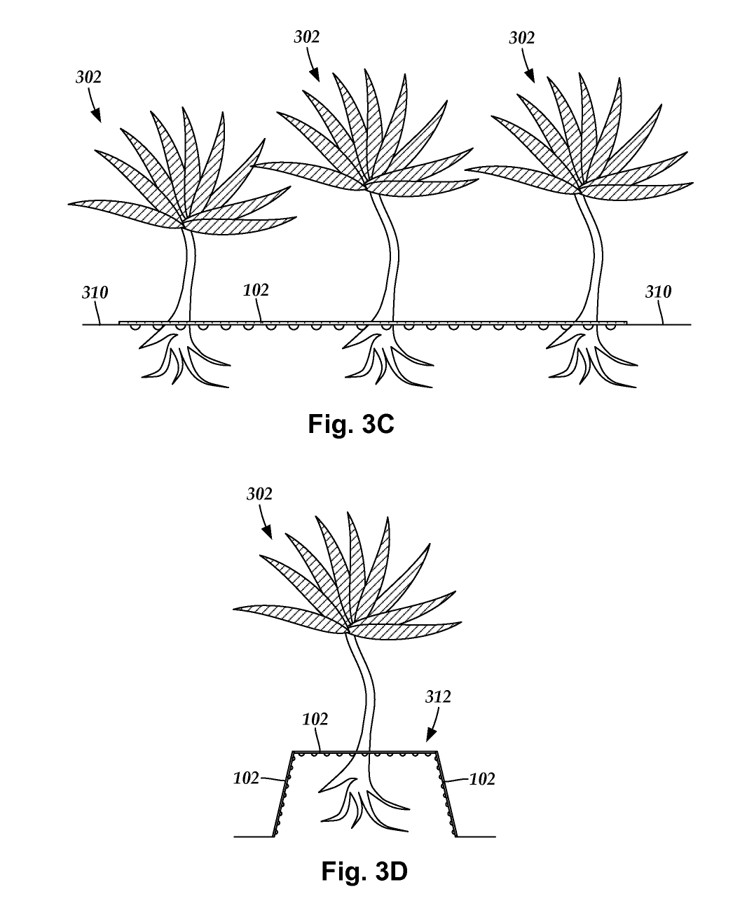

In at least some embodiments, the growth-enhancing element 102 can be formed into any suitable size and shape for providing mulch, as well as controlled-release of fertilizer, to one or more plants 302 grown in containers. FIG. 3A is a schematic side cross-sectional view of one embodiment of a plant 302 disposed in a pot 304 filled with soil 306. FIG. 3B is a schematic top view of one embodiment of the plant 302 disposed in the pot 304. A single growth-enhancing element 102 is disposed in the pot 304 over the soil 306. In at least some embodiments, the growth-enhancing element 102 is disposed over the soil 306 such that the rounded side 116 of the fertilizer 104 is facing downward. In at least some embodiments, disposing the growth-enhancing element over the soil 306 such that the rounded side 116 faces downward promotes a more controlled release of the fertilizer 104.

In FIGS. 3A-3B, the substrate 106 of the growth-enhancing element 102 is shown having a shape that is similar to a shape of a transverse cross-section of the pot 304 at the level of the soil 306. It will be understood that growth-enhancing elements 102 can be pre-formed (e.g., cut into a specific size and shape prior to being sold to a consumer) to any suitable shape and size for plants grown in containers. For example, growth-enhancing elements 102 can be pre-formed to fit conventionally-sized pots, troughs, planters, flower beds, and the like). In at least some alternative embodiments, growth-enhancing elements 102 are pre-formed into shapes that are different from the transverse cross-section of the pot 304 at the level of the soil 306.

The growth-enhancing elements 102 can be formed in any suitable size. In at least some embodiments, the growth-enhancing elements 102 have a diameter that is at least one inch, two inches, three inches, four inches, five inches, six inches, seven inches, eight inches, nine inches, ten inches, eleven inches, twelve inches, fourteen inches, sixteen inches, eighteen inches, twenty inches, twenty-four inches, or larger.

In at least some embodiments, one or more growth-enhancing elements 102 are positioned around the plant 302, as desired. In at least some embodiments, the growth-enhancing element 102 is formed with a plurality of cut-outs 108. In at least some embodiments, the growth-enhancing element 102 is formed without a cut-out 108. In at least some embodiments, a plurality of growth-enhancing elements 102 can be disposed on the soil 306 in the pot 304. In at least some embodiments, a plurality of growth-enhancing elements 102 can be disposed on the soil 306 in the pot 304 such that there is little to no overlapping of two or more of the plurality of growth-enhancing elements 102. For example, in at least some embodiments, the growth-enhancing elements 102 can be formed into strips that are laid over one or more exposed portions of the soil 306, as desired.

In at least some embodiments, the growth-enhancing element 102 can be formed into any suitable size and shape for providing mulch, as well as controlled-release of fertilizer, to one or more plants 302 that are not grown in containers. FIG. 3C is a schematic side view of one embodiment of a plurality of plants 302 disposed in soil 310 (e.g., a garden, nursery, orchard, yard, or the like). One or more growth-enhancing elements 102 are disposed over the soil 310 in proximity to the plants 302. FIG. 3D is a schematic side cross-sectional view of one embodiment of the plant 302 disposed in a berm 312. One or more growth-enhancing elements 102 are disposed around exposed portions of the berm 312.

Growth-enhancing elements 102 can be formed using any suitable method of manufacturing. Examples of suitable methods of manufacturing are found in, for example, U.S. Patent Application No. 2009/0044582, which is herein incorporated by reference. In at least some embodiments, the fertilizer 104 is deposited onto the one or more first layers 120 of the substrate 106 and then covered by the one or more second layers 122 to encapsulate the fertilizer 104 between the one or more first layers 120 and the one or more second layers 122.

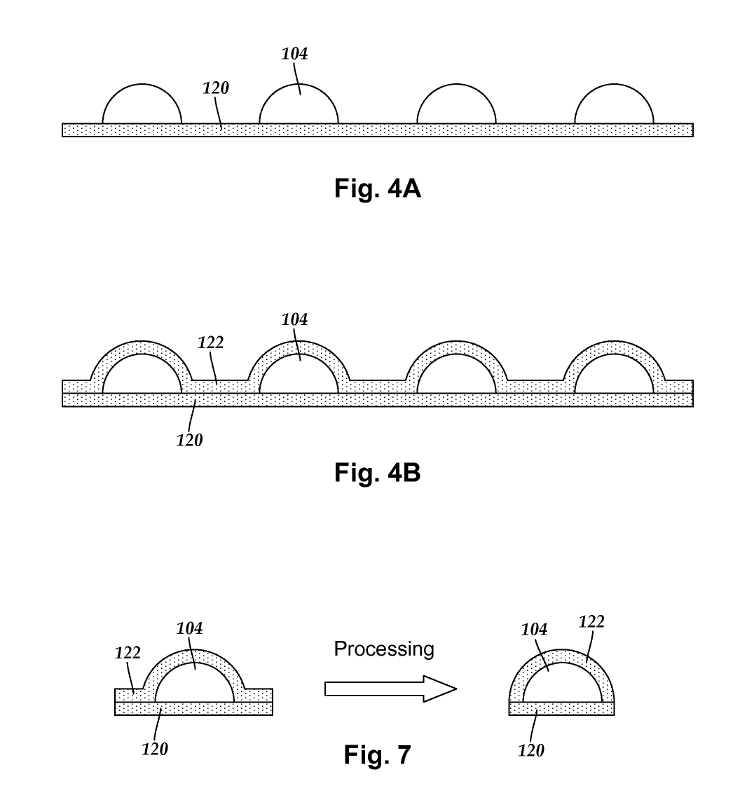

FIG. 4A is a schematic side view of one embodiment of fertilizer portions 104 disposed on the one or more first layers 120 of the substrate 106. In at least some embodiments, the fertilizer 104 is deposited onto the one or more first layers 120. In at least some embodiments, the fertilizer 104 is in a molten state when deposited onto the one or more first layers 120. In at least some embodiments, the fertilizer 104 is shaped like a hemisphere after being deposited on the one or more first layers 120. The hemispheric shape of the fertilizer 104 includes the flat side 114 abutting the one or more first layers 120 and the rounded side 116 extending outwardly from the one or more first layers 120. The flat side 114 can be used as a carrier for other chemicals by laminating paper onto it. In at least some embodiments, the one or more first layers 120 are first laminated to a paper web. Then the one or more first layers 120 are fed under a fertilizer deposition station for fertilizer 14 deposition onto the polymer side.

In at least some embodiments, the molten fertilizer portions 104 deposited on the one or more first layers 120 are cooled such that the fertilizer 104 hardens. After the fertilizer 104 hardens, the one or more second layers 122 are disposed over the one or more first layers 120 and the rounded side 116 of the fertilizer 104. FIG. 4B is a schematic side view of one embodiment of fertilizer portions 104 disposed on the one or more first layers 120, and the one or more second layers 122 disposed over the fertilizer portions 104 such that the fertilizer portions 104 are disposed between the at least one layer 120 and the one or more second layers 122.

In at least some embodiments, the one or more second layers 122 are deposited onto the one or more first layers 120 and the rounded sides 116 of the fertilizer portions 104. In at least some embodiments, the one or more second layers 122 are laminated (e.g., extrusion lamination, heat lamination, dry lamination, or the like) over the one or more first layers 120 and the rounded sides 116 of the fertilizer portions 104. In at least some embodiments, the one or more second layers 122 are extruded onto the one or more first layers 120 and the rounded sides 116 of the fertilizer portions 104. In at least some embodiments, the one or more second layers 122 are sprayed (e.g., molten resin spraying, or the like) onto the one or more first layers 120 and the rounded sides 116 of the fertilizer portions 104. In at least some embodiments, the one or more second layers 122 are formed using reactive monomers.

In at least some embodiments, the substrate 106 and fertilizer 104 are pre-formed as rolls to facilitate storage and subsequent usage. In at least some embodiments, the rolls can be cut to any suitable size, as desired. In at least some embodiments, the rolls are sent to a cutting station where growth-enhancing elements 102 are cut from the rolls. This can be achieved by any commercially available die-cutting methods such as rotary die-cutting, laser die-cutting, or other similar process used for die cutting certain shapes from a continuous roll of material(s). In at least some embodiments, the growth-enhancing elements 102 can be further cut, as desired, by a consumer.

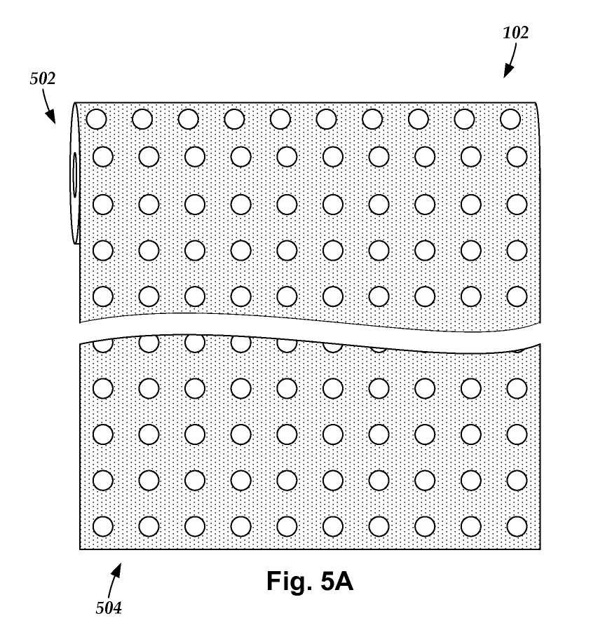

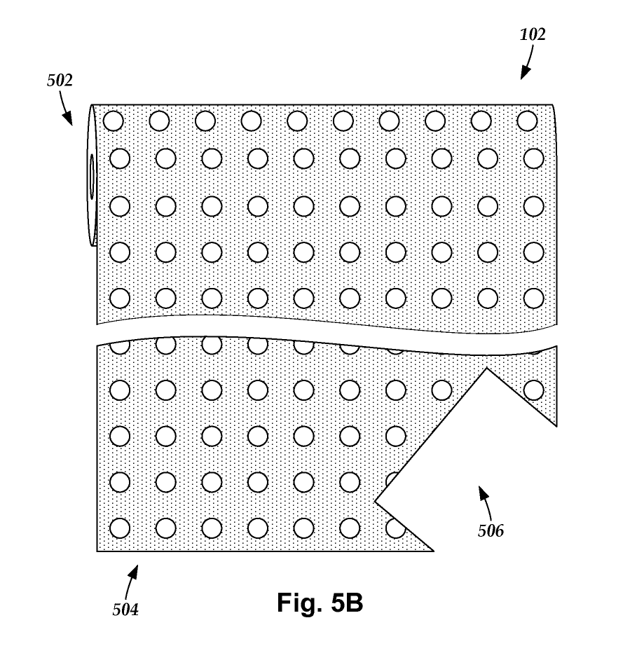

FIG. 5A is a schematic top view of a portion of one embodiment of the growth-enhancing element 102 pre-formed as a roll 502. In FIG. 5A, a distal end 504 of the roll 502 is shown unrolled. FIG. 5B is a schematic top view of a portion of one embodiment of a portion 506 of the distal end 504 of the roll 502 cut from the roll 502. In FIG. 5B, the cut portion 506 is an irregular shape. It will be understood that the cut portion 506 can be formed in any suitable size or shape, as desired. In at least some embodiments, the cut portion 506 has a shape that is similar to a shape of a transverse cross-section of a pot at a soil level.

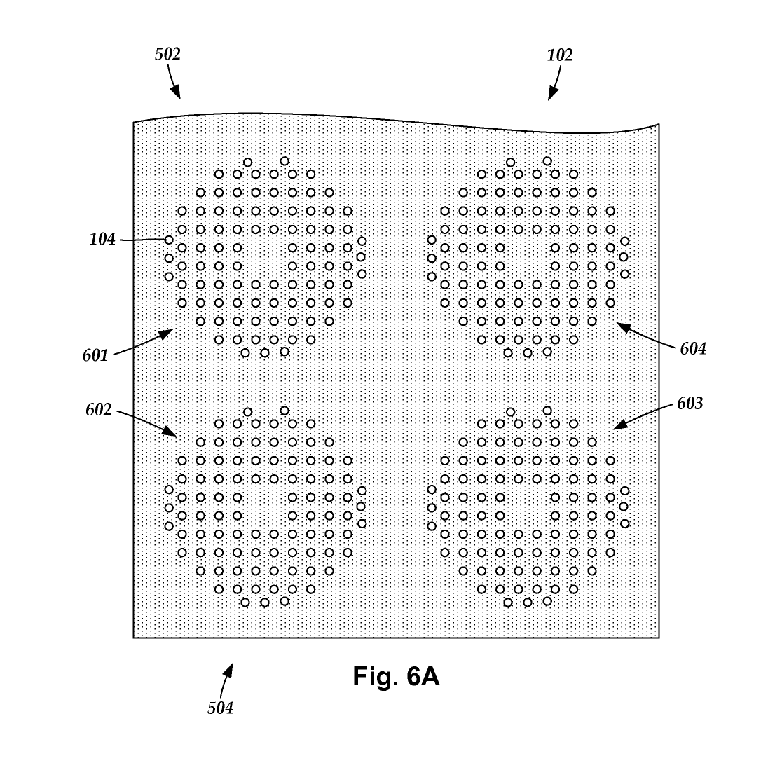

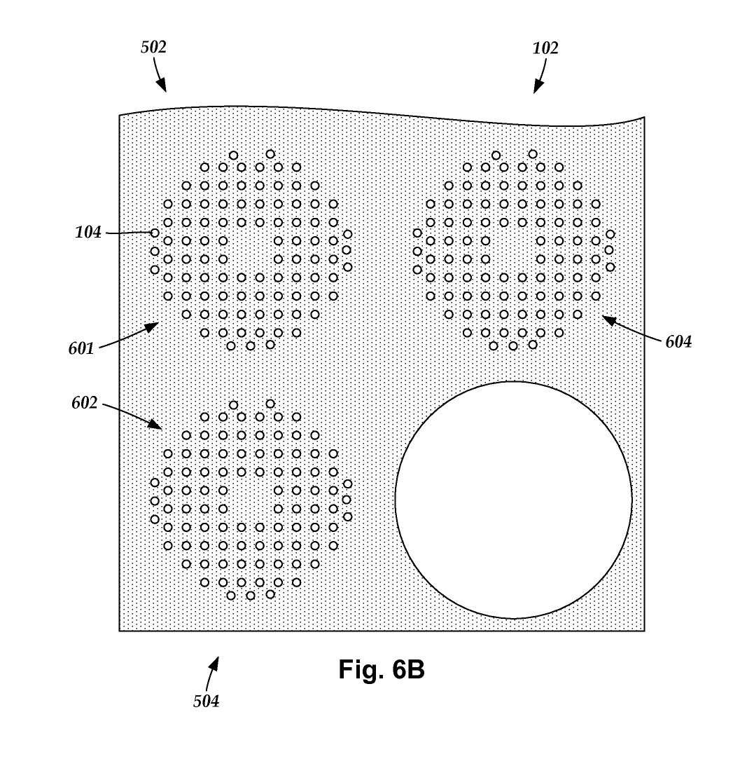

In FIGS. 5A-5B, the fertilizer portions 104 are distributed across an entire major surface of the rolls 502. In at least some embodiments, the rolls 502 are configured and arranged such that the fertilizer portions 104 are distributed on less than the entire major surface of the rolls 502. FIG. 6A is a schematic top view of one embodiment of the distal end 504 of the roll 502 laid out flat. The fertilizer portions 104 are arranged into a plurality of discrete configurations 601-604. In at least some embodiments, the configurations 601-604 are sized and shaped for cutting from the roll 502 (e.g., at a cutting station) into pre-formed growth-enhancing elements 102.

FIG. 6B is a schematic top view of one embodiment of the discrete configuration 603 cut from the roll 502. In FIG. 6B, the cut discrete configuration 603 is sized and shaped to form the growth-enhancing element 102. It will be understood that the sizes, shapes, and arrangements of the configurations 601-604 may vary according to the sizes, shapes, and arrangements of the growth-enhancing elements 102 being formed.

In at least some embodiments, when the rolls 502 are cut at a cutting station (e.g., the rolls are die-cut) into growth-enhancing elements 102, the growth-enhancing elements 102 may be further processed (e.g., using heat, or the like) to remove excess polymer (e.g., portions of the one or more first layers 120 or the one or more second layers 122) from around a periphery of the fertilizer portions 104.

FIG. 7 is a schematic side view of one embodiment a single fertilizer portion 104 disposed between the one or more first layers 120 and the one or more second layers 122. In at least some embodiments, the one or more first layers 120 and the one or more second layers 122 undergo processing to remove portions of the one or more first layers 120 and the one or more second layers 122 around the fertilizer portion 104. Removal of excess polymer may be performed using any suitable method including, for example, a heat shrink tunnel, fluidized bed heating/drying, a rotary drum heater, a heated rotary knife or laser, or the like. In at least some embodiments, the die-cut products are introduced into a heated rotary dryer where excess polymer is shrunk around the fertilizer portions 104 using heat.

It may be an advantage to apply heat processing to the growth-enhancing elements 102. The heat processing may remove some bulk of the growth-enhancing elements 102, thereby increasing the packing density of the growth-enhancing elements 102. Thus, when the growth-enhancing elements 102 are heat processed, it may be possible to increase the number of growth-enhancing elements 102 that can be disposed in a package of a given volume.

The release rate of the growth-enhancing elements 102 can be specifically tailored to fit many different growing situations. The ability to use a wide range of polymers with tight control over coating thickness can provide a very precise and predictable fertilizer release rate.

In at least some embodiments, the release rate control may be affected by how the one or more second layers 122 are disposed over the one or more first layers 120 and the exposed portions of the fertilizer 104. In at least some embodiments, the methods described above for disposing the one or more second layers 122 (e.g., laminating, extruding, and spraying) may be intermixed. In at least some embodiments, all three methods may be employed. In at least some embodiments, two of the three methods may be employed. In at least some embodiments, when different methods of applying a plurality of second layers 122 are employed, a different polymer composition may be used for at least one of the plurality of second layers 122. For example, in at least some embodiments, the plurality of second layers 122 includes an inner second layer and an outer second layer, where the inner second layer is laminated onto the top of the fertilizer 104 and the outer second layer is sprayed over the inner second layer.

In at least some embodiments, the one or more first layers 120 and the one or more second layers 122 each have two or more layers of polymers, where at least one of the layers has a different thickness from at least one of the other layers. In at least some embodiments, the one or more first layers 120 have a different thickness than the one or more second layers 122. In at least some embodiments, the one or more first layers 120 and the one or more second layers 122 are pre-manufactured using a cast/blown film extrusion or a co-extrusion process, both of which are well-known commercially and are commonly used to manufacture polymeric films of very precise thicknesses.

In at least some embodiments, one or more additives may be added into the substrate 106 during manufacturing for customizing the one or more properties of the substrate 106. For example, one or more hydrophilic additives may be added into the substrate 106 during the manufacturing to increase the fertilizer release. As another example, one or more biodegradation additives may be added into the substrate 106 for customizing the polymer rate of degradation in soil.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A growth-enhancing element for enhancing plant growth, the growth-enhancing element comprising:
a substantially-flat substrate having an outer edge, the substrate comprising
at least one first layer of polymer defining a major surface, and
at least one second layer of polymer defining a major surface, wherein the major surface of the at least one second layer of polymer is disposed over top of the major surface of the at least one first layer of polymer; and
a plurality of discrete portions of fertilizer encapsulated in the substrate such that the plurality of discrete portions of fertilizer are disposed between the at least one first layer of polymer and the at least one second layer of polymer, wherein each of the plurality of discrete portions of fertilizer have a flat side and a rounded side opposite to the flat side, wherein for each of the plurality of discrete portions of fertilizer the flat side abuts the at least one first layer of polymer and the rounded side abuts the at least one second layer of polymer;
wherein the substrate is configured and arranged to controllably release the discrete portions of fertilizer from the substrate over a period of time.

2. The growth-enhancing element of claim 1, wherein the substrate is configured and arranged to controllably release the discrete portions of fertilizer from the substrate over a period of time that is no less than one month.

3. The growth-enhancing element of claim 1, wherein the plurality of discrete portions of fertilizer are disposed between the at least one first layer of polymer and the at least one second layer of polymer in a regular pattern.

4. The growth-enhancing element of claim 1, wherein the substrate defines at least one cut-out configured and arranged to receive at least one of a stem, stalk, or a trunk of a plant.

5. The growth-enhancing element of claim 4, further defining a cut connecting the at least one cut-out to the outer edge of the substrate.

6. The growth-enhancing element of claim 1, wherein the substrate defines at least one perforation.

7. The growth-enhancing element of claim 1, wherein the substrate is impregnated with at least one insecticide.

8. The growth-enhancing element of claim 1, wherein the substrate is impregnated with at least one herbicide.

9. The growth-enhancing element of claim 1, wherein the substrate is impregnated with at least one fragrance.

10. The growth-enhancing element of claim 1, wherein printed material is disposed on the substrate.

11. The growth-enhancing element of claim 1, wherein the substrate is round.

12. The growth-enhancing element of claim 1, wherein the substrate is rectangular.

13. The growth-enhancing element of claim 1, wherein the substrate has a shape that is similar to a shape of a transverse cross-section of a pot at a soil level.

14. The growth-enhancing element of claim 1, wherein the plurality of discrete portions of fertilizer are formed from urea.

15. A method of forming a growth-enhancing element, the method comprising:
depositing a plurality of discrete portions of fertilizer onto a substantially-flat surface of at least one first layer of polymer, wherein each of the plurality of discrete portions of fertilizer has a flat side and a rounded side opposite to the flat side, wherein for each of the plurality of discrete portions of fertilizer the flat side abuts the substantially-flat surface of the at least one first layer of polymer;
applying at least one second layer of polymer to the discrete portions of fertilizer and the at least one first layer of polymer such that a substantially-flat surface of the at least one second layer of polymer is disposed over top of the substantially-flat surface of the at least one first layer of polymer to form a multi-layer substrate and the plurality of discrete portions of fertilizer are encapsulated in the multi-layer substrate such that the rounded sides of each of the plurality of discrete portions of fertilizer abuts the at least one second layer of polymer; and
cutting the multi-layer substrate into a shape that is similar to a shape of a transverse cross-section of a pot at a soil level.

16. The method of claim 15, wherein depositing the plurality of discrete portions of fertilizer onto the major surface of the at least one first layer of polymer comprises depositing the plurality of discrete portions of fertilizer into a plurality of discrete configurations.

17. The method of claim 15, wherein cutting the multi-layer substrate into a shape that is similar to a shape of a transverse cross-section of a pot at a soil level comprises cutting the multi-layer substrate into a circle.

18. The method of claim 15, wherein cutting the multi-layer substrate into a shape that is similar to a shape of a transverse cross-section of a pot at a soil level comprises cutting the multi-layer substrate into a rectangle.

19. The method of claim 15, further comprising removing excess polymer from the substrate around a periphery of at least one of the discrete portions of fertilizer.

20. The method of claim 15, further comprising impregnating the substrate with at least one of an insecticide, an herbicide, or a fragrance.
